(19) United States
(12) Patent Application Publication
(10) Pub. No.: US 2012/0215608 A1
(43) Pub. Date: Aug. 23, 2012

(54) WEB-BASED REWARD POINT SYSTEM

(76) Inventors: William J. Paulos, Las Vegas, NV (US); Jerry A. Epstein, (US); Brady J. Beutler, (US)

(21) Appl. No.: 13/033,195

(22) Filed: Feb. 23, 2011

(51) Int. Cl. G06Q 30/00

(52) U.S. Cl. 705/14.23; 705/14.39

(57) ABSTRACT

A web-based reward point system that awards points in the form of web credits to users as a reward for participating in certain online activities. The web credits are stored in a database that contains information about user accounts, web credit award activity and web credit redemption activity. The user is able to redeem web credits by receiving a voucher from the website that contains a unique voucher ID and presenting the voucher to a vendor at a business location of the vendor. The vendor is able to verify the authenticity of the voucher by checking the voucher ID at the website. In exchange for the voucher, the user receives a reward from the vendor. Alternatively, the user can load web credits onto an existing vendor loyalty card or debit/credit card which can be used as currency with the vendor.

### TECHNICAL FIELD

This invention relates to reward point systems, and more particularly, reward point systems that reward customers for participation in online activities.

### BACKGROUND OF THE ART

Points and other credits are given to customers through various methods as a reward for loyal patronage. Such reward programs exist in supermarkets, hotels, restaurants, retail stores, casinos and other vendors. Reward programs vary in how they award reward points, how reward points are accumulated and how reward points can be redeemed. Typically reward programs share, however, a common aim: giving customers an incentive to patronize a business.

In addition to increasing customer patronage and loyalty, providers of reward programs also in valuable information about their customers. This is possible because reward points are often pooled in a customer's reward account, which also tracks associated transactions. For example, a customer may open a reward account at a supermarket. Upon opening the account, the supermarket learns demographic information about the customer which it otherwise might not have known. When the customer makes purchases at the supermarket, the customer provides the reward account information. The customer's purchases may then be recorded in association with that reward account, and in turn, the customer. The supermarket may offer instantaneous rewards for using a reward account in the form of discounts at purchase time. These instantaneous rewards provide an incentive to the customer to provide the reward account information during the transaction. Eventually, a history of transactions will be associated with the customer. This history may reveal purchasing habits, including which items the customer likes to purchase and when. The supermarket may use this information to offer personalized information or discounts that are calculated to be of interest to the customer, in the hopes that such enticements will lead to additional patronage.

As another example, hotels might reward loyalty with free stays or free upgrades. As in the supermarket example, a hotel customer might supply reward account information when booking a room. Eventually, the hotel customer might accumulate enough reward points in the reward account to qualify for a free stay or a free upgrade (e.g. a larger room, free break fast, etc.) according to the rules of the hotel's reward program. Again, while the customer is accumulating reward points, the hotel is learning the cities that the customer frequents and when. In exchange, the customer qualifies for increased rewards.

As these examples illustrate, because businesses want to encourage exclusive loyalty, the reward programs that they administer are meant to only provide rewards and incentives for patronizing their business in particular. That is, many reward programs today do not typically offer the ability to transfer reward points between industries (e.g. from a hotel reward program to a supermarket reward program) and typically do not offer the ability to transfer reward points between competitors in a specific industry (e.g. from supermarket A to supermarket B). Additionally, current systems typically require the customer to make a purchase in order to qualify for reward points. As a further limitation, current reward point systems do not necessarily attract first-time customers because rewards are only available after repeated patronage.

Accordingly, there is a need for a reward point system that does not require a purchase, is not limited to a particular vendor, and allows non-customers to gain points—thereby enticing the participant to visit a vendor's business.

### SUMMARY

The present sys em implements a loyalty or rewards program that utilizes a website to award reward points, or “web credits.” In one embodiment, a rewards program provider first establishes a website where web credits can be earned, accumulated and withdrawn. A user then contacts the website in order to create an account—potentially for free. Once the account has been created, the user may participate in a number of activities on the website or in connection with the website. Participation in these activities is rewarded with web credits that are accumulated in the user's account.

The user may redeem accumulated web credits by means of the website for a variety of rewards. Redemption refers to the process of withdrawing web credits from a user account and receiving a reward from a vendor in exchange for the withdrawn web credits. One possible method of redemption allows the user to print out, or otherwise display, a voucher from the user's computer that represents the withdrawn web credits. The user may then take the voucher to a vendor's business location to receive a reward. A method is provided whereby the vendor may verify the authenticity of the presented voucher. Once verified, the vendor may provide the appropriate reward to the user.

Alternatively, the user may redeem accumulated web credits online. The user may elect to redeem accumulated web credits directly on the website of the vendor.

Alternatively, the user may transfer, or “load”, web credits onto an existing vendor loyalty card or credit/debit card belonging to the user. Upon transfer, web credits are converted to the currency or units of the existing card.

### BRIEF DESCRIPTION OF THE DRAWINGS

FIG. 1 is a block diagram of significant components used with a system in accordance with the invention;

FIG. 2 is an example of a voucher as may be used with the system of FIG. 1;

FIG. 3 is an example of an electronic transmission containing voucher information as used with the system of FIG. 1;

FIG. 4 is a data flow diagram of a user login process as may be used with the system of FIG. 1;

FIG. 5 is a data flow diagram of a web credit accumulation process as may be used with the system of FIG. 1;

FIG. 6 is a data flow diagram of a user account information retrieval process as used with the system of FIG. 1; and

FIG. 7 is a data flow diagram of a redemption process as used with the system of FIG. 1.

### DETAILED DESCRIPTION

While this invention is susceptible of embodiments in many different font's, there is shown in the drawings and will herein by described in detail preferred embodiments of the invention with the understanding that the present disclosure is to be considered as an exemplification of the principles of the invention and is not intended to limit the broad aspect of the invention to the embodiments illustrated.

The present system is capable of description by reference to its component functions and various processing steps. The present system may be realized by implementation of any number of known hardware and/or software components that have been configured or designed to implement the various components of the present invention.

The present system may be implemented with a web server, a website, a database, a user computer or a vendor computer, among other things. A user may visit a website hosted on a web server and create a user account, if a user account does not already exist. The user account information, including, among other things, login credentials, user contact information, user account history and a web credit balance, is stored in a database. A user may participate in a number of online activities in order to in web credits. A rule set dictates how many web credits are given to the user for a particular activity. Once the user has accumulated sufficient web credits in the user account, a user may withdraw web credits. Web credits may be withdrawn from the user account and transferred to vouchers, whether physical or electronic, or to a card, like an existing loyalty card or credit or debit card. The user is able to exchange withdrawn web credits for rewards from a vendor. The vendor may verify the authenticity of the voucher by querying a database that contains user account information.

The hardware used to realize the present system may be of any variety now known or yet discovered which alone, or in combination with other components, has the ability of interacting with its user through visual, aural, tactile or other means and can process, interpret and/or store such interactions such as a keyboard, mouse, trackpad, touchscreen, LCD display, CRT display, microcontroller or other embedded system, cell phone, desktop computer, laptop computer, tablet computer, server or the like.

Moreover it should be appreciated that the software used to realize the present system may be software that is written in any language and that is capable of being used on any of the hardware described herein. Further, it should be noted that the present system may employ any number of known techniques for transmitting data, signaling, data processing and the like. Communication between components or users of components of the present system may be accomplished through any suitable communication means including telephone networks, computer networks, intranets, Internet, extranet, wireless networks and the like.

As used herein, the terms “user” and “customer” shall interchangeably refer to any person or persons, or other entity who accesses and uses the system.

As used herein, the term “online” refers to interactive communications that take place between communicants who are remotely located from one another, including communication through any network or networks or any communications means described above or the like.

As used herein, the terms “vendor” or “merchant” include a person, company, legal entity or the like who accepts vouchers or web credits, as described herein, in exchange for a reward. A vendor might be, or be associated with, a retail store, restaurant, hotel, airline, casino or any provider of goods and/or services or the like.

As used herein, the term “business location” includes a physical place of business of a vendor.

As used herein, the term “web credit” includes an intangible virtual currency that represents rewards points.

As used herein, the term “provider” includes a person, company, legal entity or the like who provides the website and database described herein. The term “provider” and “vendor” may refer to the same person, company, legal entity or the like.

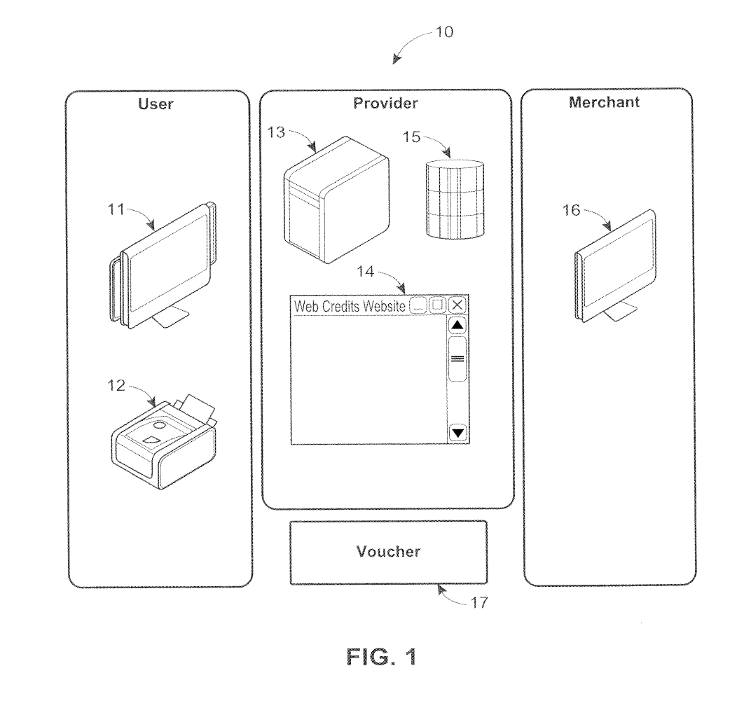

Referring first to FIG. 1, an illustration of an example system 10 for providing rewards to customers is generally shown. The system 10 includes a user computer 11, a user printer 12, a web server 13, a website 14, a database 15, a vendor, or merchant, computer 16 and a voucher 17. The user computer 11 comprises a conventional personal computer, such as a desktop computer or laptop. The user computer 11 may alternatively comprise a tablet computer, PDA, cell phone or similar device. The user computer 11 includes typical hardware and software components (not shown), such as a processor, memory and input/output devices such as a video output and control inputs for interacting with the user computer 11. The vendor computer 16 may be similar to the user computer 11.

The user printer 12 comprises a conventional printer, such as an inkjet or laser printer. The web server 13 comprises a conventional web server. Alternatively, the web server 13 may be any number of web servers working in concert, or separately, to provide user interaction with the website 14. The database 15 comprises a conventional database, whether relational or otherwise, and may include any device, system, software or method for storing and retrieving information electronically, such as a SQL database, an XML file, a flat file or the like. The website 14 comprises a typical website having any number of web pages, whether stored and delivered statically or dynamically.

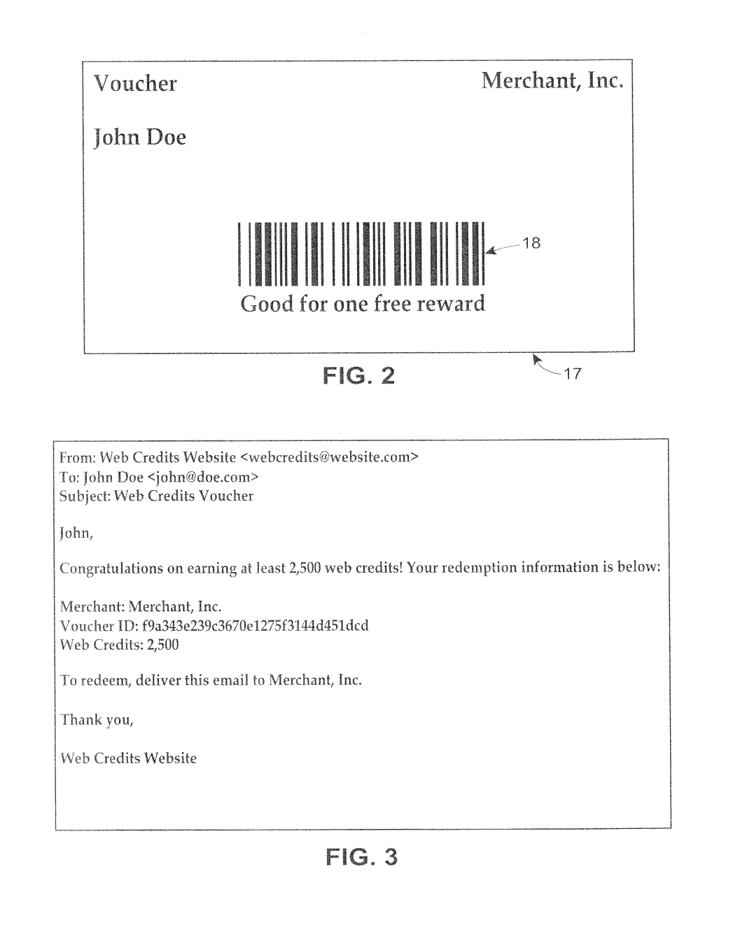

A voucher 17 is also generally shown in FIG. L. A more detailed example of the voucher 17 is shown in FIG. 2. The voucher 17 may comprise a printed document, or an electronic representation thereof, which contains a machine-accessible representation 18 of a voucher ID, such as a barcode 18, 2D code or the like. A voucher ID may be an alphanumeric sequence that represents a particular voucher 17. Alternatively, the voucher 17 may comprise a voucher ID in human readable format either in addition to, or in replacement of, a machine readable representation of a voucher ID.

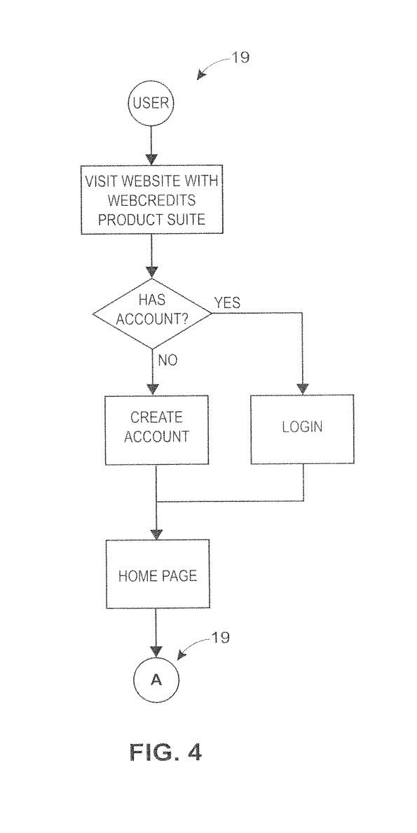

In one embodiment, the user visits the website 14, as shown in FIG. 4. The website 14 has been adapted to implement the present system. If the user does not yet have an account with the website 14, the user creates an account using the website 14. Alternatively, if the user already has an account with the website 14, the user provides the requested credentials to the website 14 and is authenticated by the website 14. Upon successful completion of either account creation or account login, the user is then taken to the home page of the website 14.

From the home page of the website 14, the user may elect any of several actions, as indicated by transitions 19 in FIGS. 3-6 and as described more fully herein: (i) participate in any of several online activities to gain web credits, (ii) retrieve account information including account balance and transaction history, and/or (iii) withdraw web credits.

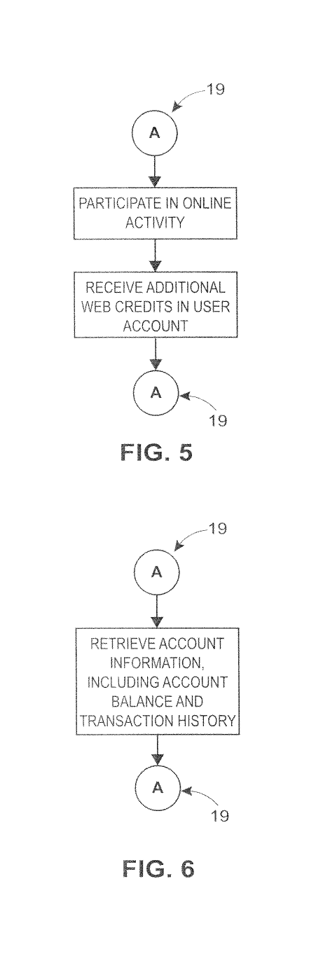

The user may participate in an online activity to gain web credits, as shown in FIG. 5. The description of these online activities is not intended to place any limitation on what such an online activity might be. However, some examples will be provided to illustrate, but in no way restrict, what is contemplated by the online activity. For example, web credits might be granted to a user for: (a) responding to an email, (b) visiting certain websites, (c) playing a game, (d) winning a game, tournament or contest, (e) recruiting other people to join the website 14, (f) accessing certain information within the website 14, (g) completing polls, or (h) making a purchase on the website 14 or elsewhere. Notification is provided to the user via the website 14 when web credits have been given to the user. Such notification may be accomplished through methods already known in the art for providing notifications to website users.

According to one embodiment, the provider of the website 14 may elect to manually award web credits to the user in the discretion of the provider. According to another embodiment, the user may elect to purchase web credits online with legal currency such as the US Dollar.

The awarding of web credits is conducted according to a rule set. The rule set is comprised of configurable rules associated with the website 14. These rules determine which online activities will be rewarded with web credits and how many web credits will be given for successful completion of those online activities. The configurable rules might take into account such external factors as the date. For example, a rule might be: award 250 web credits for completing an online survey.

Web credits are stored in the database 15. In addition to information about web credits, the database 15 may also store information about all users, user activity on the website 14 and the like. Each user may have user-specific information stored in the database 15, including (i) information collected at the time of account creation, (ii) a log of online activities, including rewards, withdrawals of web credits, transfers of web credits and redemptions of web credits, and (iii) a web credits account balance. Accordingly, when web credits are given to the user, the account for the user may be updated to include (a) a log entry reflecting the award of new web credits and (b) a correspondingly increased web credits account balance.

As shown in FIG. 6, the user may elect to retrieve account information. Account information may include contact information for the user, a report on withdrawals, transfers and redemptions of web credits and/or a current web credits account balance.

The website 14 provides the ability for the provider to view account information for any user. Additionally, the provider has the ability to generate and view reports, statistics, logs and the like on all, or a subset, of users of the website 14. The provider can use this information to track participation on the website 14. In one embodiment, this participation information, combined with account information, is used by the web server to suggest to the vendor or provider promotions that a user or plurality of users will likely have a favorable response to. Additionally, the account information for any single user, or the account information of an agregate of users of the website 14, can be used to customize the experience of the user.

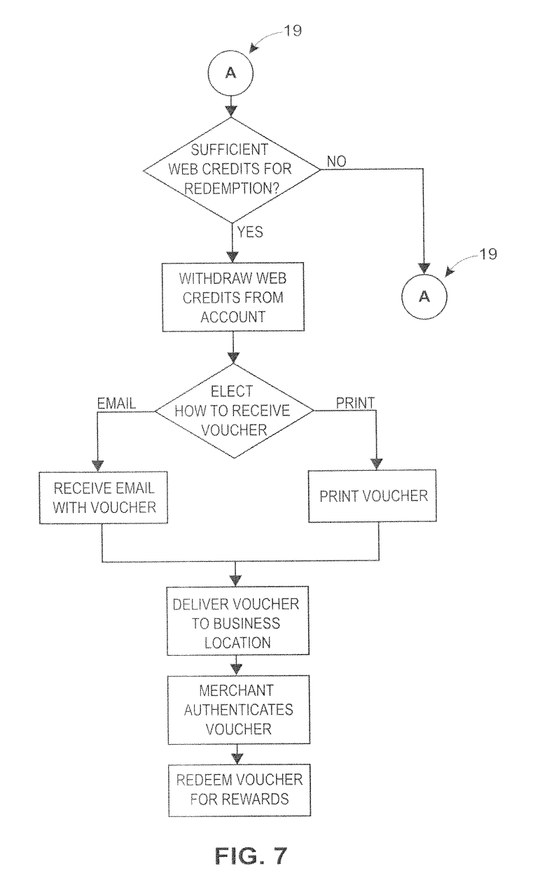

The user can elect to withdraw accumulated web credits, as shown in FIG. 7. If the user does not have sufficient web credits to perform a withdrawal, the website 14 so indicates and the user is kept from performing a withdrawal.

It should be understood that web credits can be redeemed for rewards from vendors, as defined previously. According to one embodiment, the user selects a vendor from a list of vendors. According to another embodiment, the vendor has been preselected for the user.

Redemption can be accomplished through use of the voucher 17, such as the one shown in FIG. 2. Each voucher 17 has a unique voucher ID. One redemption means includes the electronic transmission of an electronic representation of a voucher 17, as shown in FIG. 2, to the user. For the purpose of illustration and not limitation, examples of an electronic transmission include an email, a text message, a out of instructions and/or data sent to specialized software, such as an application on a mobile device, and the like. Alternatively, the electronic transmission may contain the information represented in voucher 17, including a human readable voucher ID, in an alternative format, such as plain text, as shown in FIG. 3. Another redemption means includes the printing of a voucher 17 on a user printer 12 via a user computer 11. Regardless of the means employed, when withdrawn web credits are transferred to a voucher, the associated voucher ID is stored in the database 15 along with (i) its associated value, in web credits, and (ii) an identification of the user performing the transfer. When the voucher is created, the corresponding web credits may be deducted from the web credits account balance of the user.

According to one embodiment, the user is not permitted to select the redemption means. According to another embodiment, the user is permitted to select the redemption means.

Thus, according to one embodiment, the user receives an electronic transmission with a representation of the voucher 17 and/or the information contained in the voucher 17 but not in voucher form. According to another embodiment, the user prints out the voucher 17 from either the website 14 or the electronic transmission.

Next, the user delivers the voucher 17 to the vendor at the business location of the vendor. Having the user physically visit the vendor is one of the benefits of the present system. If the electronic transmission redemption means was used, the user can deliver and present the voucher 17 on a user computer 11—preferably a portable user computer such as a smart phone, laptop or the like. When the voucher 17 is presented to the vendor, the vendor uses a vendor computer 16 to verify the authenticity of the presented voucher 17. If the voucher ID is in machine readable form, the vendor uses the appropriate machine reader to read the voucher ID found on the voucher 17. The vendor performs an online query with the database 15, supplying the voucher ID as part of the query. This query effectively presents the voucher 17 for redemption. Alternatively, this query may be made by the vendor computer 16 to the website 14, which may then query the database 15.

Verifying the authenticity of a voucher ID protects the vendor from fraud or deceit in the form of a counterfeit voucher, a duplicated voucher, an already redeemed voucher or the like. By storing voucher IDs and user activity, the database 15 may confirm whether the voucher 17 is valid and whether the voucher ID has been used previously.

The database 15 or the website 14 will respond to the query of the vendor with an indication of whether the voucher 17 is presently redeemed or the voucher 17 cannot be presently redeemed. If the voucher 17 is presently redeemed, the website 14 will log the redemption of the appropriate voucher ID in the database 15.

The voucher 17 has now been redeemed. The vendor then conveys a reward to the user. It should be understood that the reward is not intended to be restricted or limited. However, for the purpose of illustration and not limitation, examples of a reward include discounts, goods, services, promotional items and the like.

According to one embodiment, a lost or stolen voucher that has not yet been redeemed may be cancelled and a replacement voucher may be issued. After a voucher is lost or stolen, a user may visit the website 14 and locate the list of vouchers issued to the user in the user account information section of the website 14. The user may then indicate that a voucher has been lost or stolen. The website 14 may then update the database 15 to indicate that the voucher is no longer valid. This indication will prevent redemption of the voucher. If the lost or stolen voucher were then to be presented to the vendor for redemption, the vendor would learn that the voucher is invalid when the vendor inputs the voucher ID into the vendor computer 16 and the vendor computer 16 queries the website 14 or the database 15.

After the website 14 invalidates the lost or stolen voucher, the website 14 will issue a replacement voucher to the user. The replacement voucher will contain a new voucher ID that is different from the lost or stolen voucher. The replacement voucher may be issued in the same way that the lost or stolen voucher was issued, e.g. by allowing the user to print a voucher 17 or by electronically transmitting a voucher 17 to the user.

In another embodiment, the user can redeem web credits online. The user can spend the web credits as a form or currency either at the website 14 or at the website of a vendor for goods or services.

To redeem web credits at the website 14, the user may select a desired reward or rewards from among an online catalog of goods or services available at the website 14. The online catalog may indicate the cost in web credits for a particular reward or rewards. The user may request these rewards in ways presently known in the art for making purchases online. For example, the user may add a reward to a virtual shopping cart. To complete the transaction and receive the reward, the user may use web credits belonging to the user. The website 14 will verify that the user has sufficient web credits for the transaction by querying the database 15. If the user does not have sufficient web credits to receive the desired reward or rewards, the website 14 will notify the user. If the user has sufficient web credits to receive the desired reward or rewards, the number of web credits required to complete the transaction will be deducted from the web credits account balance of the user and the user will be notified that the transaction was successful. The requested reward or rewards will then be conveyed to the user.

To redeem web credits at the website of a vendor, the user first elects to withdraw web credits for use at the website of a vendor. The user then selects the number of web credits to be withdrawn. Alternatively, the user selects a reward that is available from the website of a vendor and the number of web credits required for that reward will be withdrawn. For example, a meal may be available as a reward at the website of a vendor for 75 web credits, which, if selected by the user, would cause 75 web credits to be withdrawn. The website 14 then provides to the user a promotional code (or promo code) in exchange for the withdrawn web credits. The promo code may be used at the website of a vendor to redeem the web credits for goods or services from the vendor. For example, the user may enter the promo code during the checkout process at the website of a vendor and may receive a discount on the purchase being made by the user.

Promo codes may be provided to the provider by the vendor prior to making the promo codes available to the user. The provider may specify the value of the web credits and the corresponding exchange rate between web credits and the promo codes to be provided by the vendor. For example, the provider might specify that 10,000 web credits are worth a $25 discount at the website of the vendor. The vendor would provide a promo code to the provider that effectuates a $25 discount at the website of the vendor. The provider would input the promo code into the database 15 with an indication that the promo code is worth 10,000 web credits.

Promo codes can be single-use promo codes. If single-use promo codes are used, the website 14 will create a record in the database 15 that indicates that a particular promo code has been issued and that the same promo code should not be issued again. Alternatively, the website 14 may delete a single-use promo code from the database 15 upon issuance of the single-use promo code to the user.

According to yet another embodiment, web credits can be transferred, or “loaded” onto an existing vendor loyalty card or credit/debit card belonging to the user. The user is then able to use the web credits on such cards as a form of currency with the vendor.

In order for the website 14 to transfer web credits to an existing vendor loyalty card, the provider will typically need to establish a relationship with the vendor who provides the loyalty card. The website 14 and the database 15 will need information about the vendor loyalty program and how to increase the account balance of an existing vendor loyalty card of a particular user. Generally, the account balance of an existing vendor loyalty card may be increased through online communications with the system that provides the vendor loyalty program. For example, the vendor may provide an external interface to its loyalty program through application programming interfaces, or APIs. The APIs may include functions to query the account balance of a user of the loyalty program or to increase or decrease the account balance of a user of the loyalty program. The APIs may be web-based APIs, such as those based on SOAP, REST or similar. The APIs may also be proprietary and/or non-web-based. The APIs may require authentication using login credentials, key exchange, or other access control methods including white lists. Accordingly, the provider will need to adapt the website 14 and/or the database 15 so that the present system may communicate with the system that provides the vendor loyalty program.

For example, the system that provides the vendor loyalty program may be accessible by web-based API and may require two pieces of information in order to increase the account balance of a user of the vendor loyalty program: an account number and the amount of the increase. The provider would therefore adapt the website 14 and/or the database 15 so that the website 14 collects from the user the account number belonging to the user that corresponds to the vendor loyalty program. The provider would also adapt the website 14 and/or the database 15 so that the website 14 is capable of communicating online with the system that provides the vendor loyalty program through the APIs. The provider may input into the website 14 and/or the database 15 the API endpoints and the syntax of the various API calls necessary to transfer web credits to the vendor loyalty program.

The provider may specify an exchange, or conversion, rate between web credits and the units used by the vendor in its loyalty program. For example, 10,000 web credits may be equivalent to 2,500 units in the vendor loyalty program. This exchange rate may also vary based on factors such as time of day, time of year, number of web credits to be exchanged, current web credit balance of the user, current balance of the user in the vendor loyalty program, current promotions, some special designation of the user such as a VIP, any other similar factor or other factor determined by the provider.

The user may transfer web credits to an existing vendor loyalty card by using the website 14. Using the website 14, the user may indicate, by clicking on the appropriate buttons or links, that the user elects to redeem web credits by transferring accumulated web credits to an existing vendor loyalty card. The website 14 would then ask the user for information about the existing vendor loyalty card, such as the identification of the vendor, the account number found on the existing vendor loyalty card and/or the name printed on the existing vendor loyalty card. If the website 14 is not adapted to transfer web credits to the vendor loyalty program specified by the user, the website 14 will notify the user of the inability of the website 14 to transfer web credits to the specified vendor loyalty program. If the website is adapted to transfer web credits to the vendor loyalty program specified by the user, the website 14 may: (i) verify that the user has sufficient web credits to transfer, providing a notification if the number of web credits in the account of the user is not sufficient, (ii) initiate a transfer of web credits to the vendor loyalty program by transmitting to the system that provides the vendor loyalty program the information required by that system to increase the account balance of the user of the vendor loyalty program, such as an account number and amount of increase, (iii) verifying that the transfer was successful by receiving an acknowledgement from the system that provides the vendor loyalty program and/or by querying the system that provides the vendor loyalty program to determine if the account balance of the user was appropriately increased, (iv) deducting the specified number of web credits from the account balance of the user, (v) logging in the database 15 the redemption transaction and (vi) providing notification to the user that the transfer was successful.

The user continues to accumulate web credits and redeem those web credits for additional rewards.

According to one embodiment, the provider is able to cause web credits to expire after a specified duration or at a specified date. When web credits expire, they are deducted from the web credits account balance of the user and a record is created in the database 15 reflecting the deduction. The provider would input into the website 14 and/or the database 15 rules regarding the expiration of web credits. The rules may be based on account activity, account balance, or any data available on the website 14 and/or the database 15. For example, the provider may create a rule that, in any given month, if a user does not visit the website 14 then 1,000 web credits belonging to the user will expire at the end of the month.

According to one embodiment, the voucher 17, whether in printed or electronic form, may be given an expiration date. When the voucher 17 is created by the website 14, the website 14 may make a record of the expiration date of the voucher 17 in the database 15. The expiration date may be calculated based on a fixed duration or the duration may be determined according to rules, similar to those rules that may control expiration of web credits. The expiration date of a voucher 17 may be printed or displayed on the voucher 17. Expiration dates of vouchers are enforced when the voucher 17 is presented to a vendor. When the vendor queries the website 14 or the database 15 with the voucher ID, the present system will determine if the presented voucher 17 has expired by comparing the current date with the expiration date of the voucher stored in the database 15. If the voucher 17 has expired, the vendor will be notified that the voucher 17 is not valid.

While specific embodiments have been illustrated and described, numerous modifications may come to mind without significantly departing from the spirit of the invention, and the scope of protection is only limited by the scope of the accompanying claims.

1. A method of operating a reward point program in conjunction with a website and a vendor, the method comprising:
providing a web server adapted to serve the website,
providing a database that stores a user account, said user account associated with a user and an account balance that represents an accumulation of web credits of said user,
the user participating in an online activity,
the user receiving a plurality of web credits according to a rule set,
the plurality of web credits being added to the account balance, and
the user redeeming the accumulated web credits at a business location of the vendor for a reward.

2. The method of claim 1 wherein the user redeems the accumulated web credits by printing a voucher that is generated by the website and delivering the voucher to the vendor at a business location of the vendor.

3. The method of claim 2 wherein the database stores a voucher ID when the voucher is created.

4. The method of claim 2 wherein the vendor authenticates the voucher by performing a query with the database using the voucher ID and the database indicating that the voucher ID is redeemed as a result of the query.

5. The method of claim 2 wherein the voucher includes a machine readable voucher ID.

6. The method of claim 2 wherein the voucher includes a human readable voucher ID.

7. The method of claim 1 wherein the user redeems the accumulated web credits by receiving an electronic transmission containing a voucher that is sent by the website and presenting the voucher to the vendor at a business location of the vendor.

8. The method of claim 7 wherein the database stores a voucher ID when the voucher is created.

9. The method of claim 7 wherein the vendor authenticates the voucher by performing a query with the database using the voucher ID and the database indicating that the voucher ID is redeemed as a result of the query.

10. The method of claim 7 wherein the voucher includes a machine readable voucher ID.

11. The method of claim 7 wherein the voucher includes a human readable voucher ID.

12. The method of claim 1 wherein the user redeems the accumulated web credits online with the vendor.

13. The method of claim 1 wherein the user obtains a plurality of web credits by means of an online purchase of said plurality of web credits.

14. The method of claim 1 wherein the user redeems the accumulated web credits by transferring a plurality of accumulated web credits to an existing vendor loyalty card belonging to the user.

15. The method of claim 1 wherein the user redeems the accumulated web credits by transferring a plurality of accumulated web credits to an existing credit or debit card belonging to the user.
